(19) United States
(12) Patent Application Publication
(10) Pub. No.: US 2026/0188681 A1
(43) Pub. Date: Jul. 2, 2026

(54) DISPERSING MEDIUM FOR PRODUCING A CATHODE AQUEOUS SLURRY, METHOD FOR PRODUCING THE SAME, AND SECONDARY BATTERY COMPRISING THE SAME

(71) Applicant: UIF (University Industry Foundation), Yonsei University, Seoul (KR)

(72) Inventors: Sang Young LEE, Seoul (KR); Won Yeong KIM, Seoul (KR); Seok Ju LEE, Seoul (KR)

(73) Assignee: UIF (University Industry Foundation), Yonsei University, Seoul (KR)

(21) Appl. No.: 19/431,693

(22) Filed: Dec. 23, 2025

(30) Foreign Application Priority Data
Jan. 2, 2025 (KR) 10-2025-0000120

(51) Int. Cl. H01M 4/62; H01M 4/02; H01M 4/04

(52) U.S. Cl. CPC H01M 4/622; H01M 4/0416; H01M 2004/028

(57) ABSTRACT

The present invention relates to a dispersing medium for producing a cathode aqueous slurry, a method for producing the same, and a secondary battery comprising the same, and by including a metal salt, a water-soluble polymer, and an aqueous solvent, the chemical stability of the cathode active material vulnerable to moisture can be secured, thereby improving the excellent charge/discharge efficiency and life characteristics of the secondary battery.

### CROSS-REFERENCES TO RELATED APPLICATIONS

This application claims priority to Korean Patent Application No. 10-2025-0000120 filed on Jan. 2, 2025, and all the benefits accruing therefrom under 35 U.S.C. 119, the contents of which in its entirety are herein incorporated by reference.

### BACKGROUND OF THE INVENTION

### Technical Field

The present invention relates to a dispersing medium for producing a cathode aqueous slurry that can secure the chemical stability of a cathode active material vulnerable to moisture, a method for producing the same, and a secondary battery comprising the same.

### Background Art

As climate change due to global warming accelerates, a transition from indiscriminate use of fossil energy to sustainable energy production and efficient consumption is inevitable.

The world is presenting various eco-friendly policies aiming for carbon neutrality by 2050, and among them, electric vehicles are considered a core element to solve this. Therefore, establishing an eco-friendly manufacturing system for energy storage devices is essential for the efficiency and long-term viability of sustainable energy.

The production of electrodes for commercially used lithium secondary batteries is based on carcinogenic organic solvents and fluorine-based polymers that are difficult to recycle. If these are replaced with water and cellulose-based polymers, the price of materials used can be reduced by 99% compared to existing materials due to abundant resources, and the process cost can be reduced by 40% due to eco-friendly manufacturing processes and the shortening of the solvent recovery process.

However, side reactions between water and conventional active materials cause instability of the active materials, increase the basicity of water, and cause corrosion of the current collector. This negatively affects the physical and electrochemical properties of the secondary battery, making practical application difficult.

As a solution to this, various attempts such as acid addition and current collector coating have been reported, but the fundamental instability with the active material remains unresolved.

Therefore, a method is required that can utilize the advantages of aqueous electrodes while solving the instability with existing active materials.

### PRIOR ART DOCUMENTS

### Patent Documents

1. Korean Patent Application Publication No. 2022-0120551
2. Korean Patent No. 1438304

### BRIEF SUMMARY OF THE INVENTION

An object of the present invention is to provide a dispersing medium for producing a cathode aqueous slurry that can secure the chemical stability of a cathode active material vulnerable to moisture.

Another object of the present invention is to provide a cathode aqueous slurry comprising the dispersing medium for producing a cathode aqueous slurry.

Still another object of the present invention is to provide a cathode comprising a cathode active material layer manufactured from the cathode aqueous slurry.

Still another object of the present invention is to provide a secondary battery comprising the cathode.

Still another object of the present invention is to provide a device comprising the secondary battery.

Still another object of the present invention is to provide a method for producing a dispersing medium for producing a cathode aqueous slurry that can secure the chemical stability of a cathode active material vulnerable to moisture.

To achieve the above object, the dispersing medium for producing a cathode aqueous slurry of the present invention comprises a metal salt, a water-soluble polymer, and an aqueous solvent, wherein the anion forming the metal salt may be monofluorophosphate (PO₃F²⁻).

The metal cation that can combine with the anion to form a metal salt may be an alkali metal ion, an alkaline earth metal ion, or a transition metal ion.

The alkali metal ion, alkaline earth metal ion, or transition metal ion may be selected from the group consisting of Li⁺, Na⁺, K⁺, Rb⁺, Cs⁺, Fr⁺, Be²⁺, Mg²⁺, Ca²⁺, Sr²⁺, Ba²⁺, Ra²⁺, and Zn²⁺.

The metal salt may be at least one selected from the group consisting of lithium monofluorophosphate (Li₂PO₃F), sodium monofluorophosphate (Na₂PO₃F), and zinc monofluorophosphate (ZnPO₃F).

The water-soluble polymer may be at least one selected from the group consisting of carboxymethyl cellulose (CMC), polyacrylic acid (PAA), polyvinylpyrrolidone (PVP), and polyvinyl alcohol (PVA).

The aqueous solvent may be a protic polar solvent, and preferably may be at least one selected from the group consisting of water, alcohol, acetic acid, and formic acid.

The metal salt may be contained at a molar concentration of 0.1 to 5.0.

The mixture consisting of the metal salt and the aqueous solvent and the water-soluble polymer may be mixed at a weight ratio of 1:0.001 to 0.5.

Preferably, at least one metal salt selected from the group consisting of lithium monofluorophosphate (Li₂PO₃F), sodium monofluorophosphate (Na₂PO₃F), and zinc monofluorophosphate (ZnPO₃F); at least one water-soluble polymer selected from the group consisting of carboxymethyl cellulose (CMC), polyacrylic acid (PAA), polyvinylpyrrolidone (PVP), and polyvinyl alcohol (PVA); and at least one aqueous solvent selected from the group consisting of water, alcohol, acetic acid, and formic acid; are included, and the mixture consisting of the metal salt and the aqueous solvent and the water-soluble polymer are mixed at a weight ratio of 1:0.001 to 0.5, and the metal salt may be contained at a molar concentration of 0.1 to 5.0.

Furthermore, the cathode aqueous slurry of the present invention for achieving the aforementioned another object comprises the dispersing medium for producing a cathode aqueous slurry, a cathode active material, and a conductive material.

Furthermore, the cathode of the present invention for achieving the aforementioned still another object may comprise a cathode current collector; and a cathode active material layer manufactured from the cathode aqueous slurry on one surface or both surfaces of the cathode current collector.

Furthermore, the secondary battery of the present invention for achieving the aforementioned still another object may comprise the cathode.

Furthermore, the device of the present invention for achieving the aforementioned still another object is a device comprising the secondary battery, and the device may be any one selected from a communication device, a transport device, and an energy storage device.

Furthermore, the method for producing the dispersing medium for producing a cathode aqueous slurry of the present invention for achieving the aforementioned still another object comprises (A) a step of mixing a metal salt and an aqueous solvent; and (B) a step of mixing the mixed mixture and a water-soluble polymer; wherein the anion forming the metal salt may be monofluorophosphate (PO₃F²⁻).

The dispersing medium for producing a cathode aqueous slurry of the present invention suppresses the reactivity of the cathode active material vulnerable to moisture toward moisture, thereby securing chemical stability, so that a secondary battery having a stable interfacial structure and excellent charge/discharge performance can be obtained.

Furthermore, the dispersing medium for producing a cathode aqueous slurry of the present invention is not only eco-friendly but also can significantly improve electrode manufacturing productivity. Specifically, since organic solvents and fluorine-based polymers are not used, it is harmless to humans and the environment, the materials used are very inexpensive compared to existing organic solvent processes, and production costs can be greatly reduced by shortening the solvent recovery process.

### BRIEF DESCRIPTION OF THE DRAWINGS

FIG. 1 is a graph measuring sodium fluorophosphate salt (Na₂PO₃F), lithium acetate salt (LiOAc), lithium trifluoromethanesulfonate salt (LiOTf), and lithium bis(trifluoromethane)sulfonylimide salt (LiTFSI), which are metal salts, by FT-IR.

FIG. 2 schematically illustrates the case of using the dispersing medium for producing a cathode aqueous slurry manufactured according to Example 1 and Comparative Example 1 of the present invention.

FIG. 3 is a graph measuring the price of the dispersing medium for producing a cathode aqueous slurry manufactured according to Example 1, Comparative Example 1, and Comparative Example 2 of the present invention.

FIG. 4 is a graph measuring the discharge specific capacity of the lithium secondary batteries manufactured according to Example 1, Comparative Example 1, and Comparative Example 2 of the present invention.

### DETAILED DESCRIPTION OF THE INVENTION

The present invention relates to a dispersing medium for producing a cathode aqueous slurry that can secure the chemical stability of a cathode active material vulnerable to moisture, a method for producing the same, and a secondary battery comprising the same.

Hereinafter, the present invention will be described in detail.

The dispersing medium for producing a cathode aqueous slurry of the present invention is one that can secure the chemical stability of a cathode active material vulnerable to moisture and comprises a metal salt, a water-soluble polymer, and an aqueous solvent.

Since the present invention uses a metal salt, a water-soluble polymer, and an aqueous solvent together, stability against a cathode active material having high sensitivity to moisture can be secured, and in particular, it can be applied even to high-capacity cathode active materials such as high-nickel lithium metal oxides that are extremely vulnerable to moisture.

The metal salt is formed by an anion and a metal cation that can combine with the anion.

The anion is a Kosmotropic anion having high kosmotropicity among the Hofmeister series, and has a high charge density and electrostatic potential compared to a chaotropic anion (chaotropic anion, ex bis(trifluoromethanesulfonyl)imide (TFSI-)), and shows strong interaction with the solvent. Specifically, the anion is ionized to control the interaction (interaction energy, number of bonds, bond distance, orientation, etc.) with the aqueous solvent molecules. Accordingly, when an anion that forms a strong hydrogen bond with the aqueous solvent is adopted, free water in the dispersing medium is reduced to lower the activity of the aqueous solvent, thereby effectively suppressing the reaction between the cathode active material and the aqueous solvent molecules, thereby improving the chemical stability of the cathode active material. This can manufacture an eco-friendly cathode with a stable interfacial structure and excellent charge/discharge performance secured.

The anion used in the present invention includes monofluorophosphate (PO₃F²⁻). If SO₄²⁻, CH₃COO⁻ (OAc⁻), C₂F₃O₂⁻ (TFA⁻), Cl⁻, NO₃⁻, BF₄⁻, (PO₄)³⁻, (CF₃SO₂)₂N⁻ (TFSI⁻), and CF₃O₃S⁻(OTf⁻) are used as the anion instead of the anion used in the present invention, the chemical stability of the cathode active material may not be improved compared to the case where the anion of the present invention is used, and the excellent charge/discharge efficiency and life characteristics of the secondary battery may be deteriorated compared to the present invention.

Furthermore, the metal cation that can combine with the anion is not particularly limited as long as it is a metal cation that can combine with the kosmotropic anion, but preferably includes an alkali metal ion, an alkaline earth metal ion, or a transition metal ion, more preferably may be selected from the group consisting of Li⁺, Na⁺, K⁺, Rb⁺, Cs⁺, Fr⁺, Be²⁺, Mg²⁺, Ca²⁺, Sr²⁺, Ba²⁺, Ra²⁺, and Zn²⁺, and even more preferably may be selected from the group consisting of Li⁺, Na⁺, and Zn²⁺.

The metal salt of the present invention is not particularly limited as long as it can improve the chemical stability of the cathode active material, but preferably includes at least one selected from the group consisting of lithium monofluorophosphate (Li₂PO₃F), sodium monofluorophosphate (Na₂PO₃F), and zinc monofluorophosphate (ZnPO₃F), and more preferably sodium monofluorophosphate (Na₂PO₃F) may be used in terms of excellent active material stability.

In the present invention, the metal salt is contained at a molar concentration of 0.1 to 5.0 M, preferably 0.2 to 3.0 M, more preferably 0.3 to 2.0 M, and even more preferably 0.4 to 0.8 M. If the content of the metal salt is less than 0.1 M, stability against the aqueous solvent may be lowered, and if it exceeds 5.0 M, stability against the aqueous solvent is secured, but compatibility with the water-soluble polymer is poor, which may shorten the life of the secondary battery.

Furthermore, the aqueous solvent is used instead of conventional organic solvents, and preferably is a protic polar solvent, and more preferably includes at least one selected from the group consisting of water, alcohol, acetic acid, and formic acid, and even more preferably includes water.

Furthermore, the water-soluble polymer is eco-friendly and helps the strong interaction between the anion and the aqueous solvent, and is not particularly limited as long as it is a water-soluble polymer material, but preferably includes at least one selected from the group consisting of carboxymethyl cellulose (CMC), polyacrylic acid (PAA), polyvinylpyrrolidone (PVP), and polyvinyl alcohol (PVA).

In the present invention, the mixture consisting of the metal salt and the aqueous solvent and the water-soluble polymer are mixed at a weight ratio of 1:0.001 to 0.5, preferably 1:0.005 to 0.2, more preferably 1:0.01 to 0.1, and even more preferably 1:0.02 to 0.05. If the content of the water-soluble polymer based on the mixture consisting of the metal salt and the aqueous solvent is less than the weight ratio of 0.001, problems of electrode detachment from the current collector may occur after drying, and if it exceeds a weight ratio of 0.5, ion/electron conductivity within the electrode may decrease, leading to an increase in resistance.

Furthermore, in the dispersing medium for producing a cathode aqueous slurry according to the present invention, it is preferable that: \textcircled{1} the metal salt is at least one selected from the group consisting of lithium monofluorophosphate (Li₂PO₃F), sodium monofluorophosphate (Na₂PO₃F), and zinc monofluorophosphate (ZnPO₃F); \textcircled{2} the water-soluble polymer is at least one selected from the group consisting of carboxymethyl cellulose (CMC), polyacrylic acid (PAA), polyvinylpyrrolidone (PVP), and polyvinyl alcohol (PVA); \textcircled{3} the aqueous solvent is at least one selected from the group consisting of water, alcohol, acetic acid, and formic acid; \textcircled{4} the mixture consisting of the metal salt and the aqueous solvent and the water-soluble polymer are mixed at a weight ratio of 1:0.001 to 0.5; and \textcircled{5} the metal salt is contained at a molar concentration of 0.1 to 5.0 M.

As a result of manufacturing a dispersing medium for producing a cathode aqueous slurry while varying the above conditions, applying it to a secondary battery, and performing charge/discharge by a conventional method to evaluate life characteristics, in the case where even one of the above conditions was not satisfied, the stability with the cathode active material and the life characteristics of the secondary battery decreased to an observable extent compared to the case where all the above conditions were satisfied. Furthermore, in the case where even one of the above conditions was not satisfied, corrosion of the aluminum current collector due to increased pH and electrode delamination phenomenon were observed to some extent, whereas in the case where all the above conditions were satisfied, corrosion of the aluminum current collector and electrode delamination phenomenon were not observed at all within the observable range.

Furthermore, the present invention can provide a cathode aqueous slurry comprising the dispersing medium for producing a cathode aqueous slurry according to the present invention, a cathode active material, and a conductive material.

The content of the cathode active material relative to the total weight of the cathode aqueous slurry composition may be 40 to 70 wt %, preferably 40 to 60 wt %, and more preferably 40 to 50 wt %.

The cathode active material is not particularly limited as long as it is a conventional cathode active material, but preferably includes lithium cobalt composite oxide (LiCoO₂), spinel crystal type lithium manganese composite oxide (LiMn₂O₄), lithium manganese composite oxide (LiMnO₂), lithium nickel composite oxide (LiNiO₂), lithium iron phosphate (lithium iron phosphate; LiFePO₄), lithium manganese phosphate (LiMnPO₄), lithium cobalt phosphate (LiCoPO₄), lithium iron pyrophosphate (iron pyrophosphate; Li₂FeP₂O₇), lithium niobium composite oxide (LiNbO₂), lithium iron composite oxide (LiFeO₂), lithium magnesium composite oxide (LiMgO₂), lithium copper composite oxide (LiCuO₂), lithium zinc composite oxide (LiZnO₂), lithium molybdenum composite oxide (LiMoO₂), lithium tantalum composite oxide (LiTaO₂), lithium tungsten composite oxide (LiWO₂), lithium rich manganese nickel cobalt composite oxide (xLi₂MnO₃(1-x)LiMn₁₋Ni_{y}Co_{z}O₂), lithium nickel cobalt aluminum composite oxide (LiNi_{0.8}Co_{0.15}Al_{0.05}O₂), nickel manganese oxide (LiNi_{0.5}Mn_{1.5}O₄), and lithium nickel cobalt manganese composite oxide (LiNi_{0.33}Co_{0.33}Mn_{0.33}O₂, LiNi_{0.4}Co_{0.2}Mn_{0.4}O₂, LiNi_{0.5}Co_{0.2}Mn_{0.3}O₂, LiNi_{0.6}Co_{0.2}Mn_{0.2}O₂, LiNi_{0.7}Co_{0.15}Mn_{0.15}O₂, LiNi_{0.8}Co_{0.1}Mn_{0.1}O₂), and is not limited thereto.

The conductive material is not particularly limited as long as it is a conventional conductive material, but may preferably be carbon-based, and the carbon-based conductive material includes point carbon-based conductive materials, linear carbon-based conductive materials, plate-like carbon-based conductive materials, or mixtures thereof. The point carbon-based conductive materials include acetylene black, Ketjen black, channel black, furnace black, lamp black, thermal black, carbon black, and the like; the linear carbon-based conductive materials include carbon nanotubes, conductive carbon fibers, and the like; and the plate-like carbon-based conductive materials include graphene (including GRO) and the like.

Furthermore, the present invention can provide a cathode comprising a cathode current collector; and a cathode active material layer manufactured from the cathode aqueous slurry according to the present invention on one surface or both surfaces of the cathode current collector.

Examples of the cathode current collector include aluminum, copper, nickel, titanium, zinc, carbon, or combinations thereof, and preferably include aluminum.

Furthermore, the present invention can provide a secondary battery comprising the cathode according to the present invention.

Hereinafter, a secondary battery according to one example will be described, but it is obvious that it can be manufactured in a structure known in the art using conventional manufacturing methods and materials in the art, except for comprising the cathode manufactured from the dispersing medium for producing a cathode slurry according to one example.

A secondary battery according to one example may comprise a cathode manufactured from the dispersing medium for producing a cathode slurry, an anode, and an electrolyte.

The anode may comprise an anode current collector and an anode active material layer formed on the anode current collector.

Examples of the anode current collector include foils manufactured from copper, gold, nickel, or copper alloys, or combinations thereof.

The anode active material layer may be one or more selected from the group consisting of: any one carbon selected from soft carbon, hard carbon, artificial graphite, natural graphite, expanded graphite, carbon fiber, non-graphitizing carbon, carbon black, carbon nanotubes, acetylene black, Ketjen black, graphene, fullerene, activated carbon, and meso carbon microbeads; any one metal selected from silicon, tin, lithium, aluminum, silver, bismuth, indium, germanium, lead, platinum, titanium, zinc, manganese, cadmium, cerium, copper, cobalt, nickel, and iron; an alloy comprising two or more of the metals; and an oxide of one or more of the metals; and preferably may be lithium metal, but is not limited thereto.

Furthermore, the electrolyte may be a liquid electrolyte, a solid electrolyte, or a combination thereof, specifically may be a liquid electrolyte, and the liquid electrolyte may comprise a non-aqueous organic solvent and a lithium salt.

The non-aqueous organic solvent may be selected from a cyclic carbonate-based solvent, a linear carbonate-based solvent, and mixed solvents thereof, and the cyclic carbonate-based solvent is ethylene carbonate, propylene carbonate, butylene carbonate, vinylene carbonate, vinylethylene carbonate, fluoroethylene carbonate, and mixtures thereof, and the linear carbonate-based solvent may be selected from the group consisting of dimethyl carbonate, diethyl carbonate, dipropyl carbonate, ethylmethyl carbonate, methylpropyl carbonate, methyl isopropyl carbonate, ethylpropyl carbonate, and mixtures thereof.

As the lithium salt, one or more selected from the group consisting of LiPF₆, LiBF₄, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlO₄, LiAlCl₄, LiCl, and LiI can be mixed and used, but is not limited thereto. Furthermore, the concentration of the lithium salt may be included from 0.6 M to 2.0 M.

Furthermore, the secondary battery according to one example may further comprise a separator, and the separator is not limited as long as it is conventionally used in the art, but preferably may be one selected from glass fiber, polyester, polyethylene, polypropylene, polytetrafluoroethylene, or combinations thereof, may be in the form of a nonwoven fabric or a woven fabric, and may optionally be used in a single-layer or multi-layer structure.

The shape of the secondary battery according to one example is not particularly limited as long as it can house the cathode, anode, separator, and electrolyte, but preferably may be cylindrical, coin, pouch, planar, or laminate type.

Furthermore, the present invention can provide a method for producing a dispersing medium for producing a cathode aqueous slurry.

The method for producing a dispersing medium for producing a cathode aqueous slurry of the present invention may comprise (A) a step of mixing a metal salt and an aqueous solvent; and (B) a step of mixing the mixed mixture and a water-soluble polymer.

Hereinafter, preferred examples are presented to help understand the present invention, but it is obvious to those skilled in the art that the following examples are merely illustrative of the present invention and various changes and modifications are possible within the scope and technical spirit of the present invention, and it is natural that such variations and modifications fall within the scope of the appended claims.

### Example 1

### Dispersing Medium for Producing Cathode Aqueous Slurry

Sodium fluorophosphate salt (Na₂PO₃F) was mixed with water at a molar concentration of 0.5 M to obtain a mixture, and then the mixture and the water-soluble polymer, carboxymethyl cellulose (CMC, Carboxymethyl cellulose), were mixed at a weight ratio of 1:0.03 to obtain a dispersing medium for producing a cathode aqueous slurry.

### Cathode Aqueous Slurry

A cathode aqueous slurry was obtained by mixing the cathode active material LiNi_{0.8}Mn_{0.1}Co_{0.1}O₂ (NCM811)/the conductive material carbon/the water-soluble polymer in the dispersing medium for producing the cathode aqueous slurry at a weight ratio of 94/3/3.

The content of the water-soluble polymer is the content of the water-soluble polymer contained in the dispersing medium for producing the cathode aqueous slurry, and the dispersing medium for producing the cathode aqueous slurry is used so that the content of the water-soluble polymer contained in the dispersing medium for producing the cathode aqueous slurry becomes 3 parts by weight.

### Cathode

The cathode aqueous slurry was coated on an aluminum (Al) current collector of 18 μm using a doctor blade, and vacuum dried at 60° C. for 12 hours to remove water, thereby forming a cathode active material layer with a thickness of 150 μm.

### Lithium Secondary Battery

An NCM811 cathode active material, a polyethylene separator, and a lithium (Li) metal anode with a thickness of 200 μm were stacked and assembled, and then 1 M LiPF6 in ethylene carbonate (EC)/diethyl carbonate (DEC) 87 wt %, fluoroethylene carbonate (FEC) 11 wt %, and vinylene carbonate (VC) 2 wt % electrolyte was injected into the separator to manufacture an NCM811∥Li cell.

### Comparative Example 1

### Water-Based Dispersing Medium for Producing Cathode Aqueous Slurry

A dispersing medium for producing a cathode aqueous slurry was obtained by mixing water and the water-soluble polymer, carboxymethyl cellulose (CMC, carboxymethyl cellulose), at a weight ratio of 1:0.03.

Cathode Aqueous Slurry. Cathode, Lithium Secondary Battery

An NCM811∥Li cell was manufactured in the same manner as in Example 1, except that the dispersing medium for producing a cathode aqueous slurry manufactured in Comparative Example 1 was used instead of the dispersing medium for producing a cathode aqueous slurry manufactured in Example 1.

### Comparative Example 2

### LiTFSI Dispersing Medium for Producing Cathode Aqueous Slurry

A mixture was obtained by mixing lithium bis(trifluoromethane)sulfonylimide salt (LiTFSI) with water at a molar concentration of 1.0 M, and then the mixture and the water-soluble polymer, carboxymethyl cellulose (CMC, carboxymethyl cellulose), were mixed at a weight ratio of 1:0.03 to obtain a dispersing medium for producing a cathode aqueous slurry.

Cathode Aqueous Slurry. Cathode, Lithium Secondary Battery

An NCM811∥Li cell was manufactured in the same manner as in Example 1, except that the dispersing medium for producing a cathode aqueous slurry manufactured in Comparative Example 2 was used instead of the dispersing medium for producing a cathode aqueous slurry manufactured in Example 1.

### Test Example

### Test Example 1. Measurement of Interaction with Water Molecules According to Type of Metal Salt

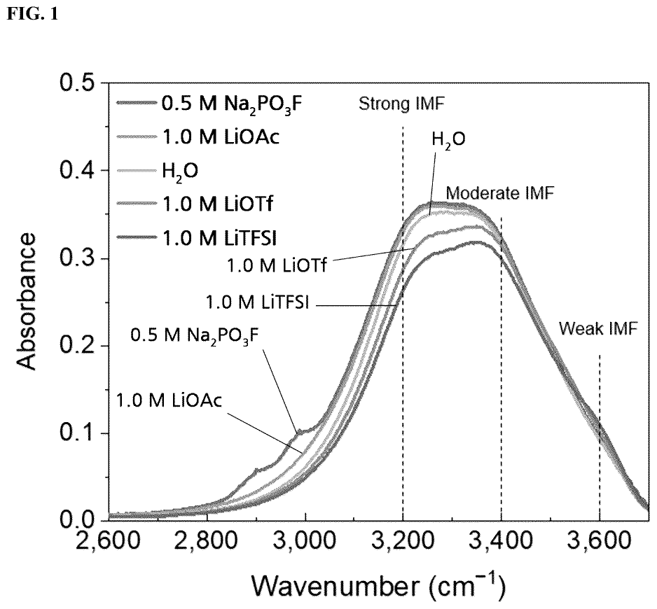

FIG. 1 is a graph measuring sodium fluorophosphate salt (Na₂PO₃F), lithium acetate salt (LiOAc), lithium trifluoromethanesulfonate salt (LiOTf), and lithium bis(trifluoromethane)sulfonylimide salt (LiTFSI), which are metal salts, by FT-IR.

As shown in FIG. 1, among the metal salts, the monofluorophosphate (PO₃F²⁻) anion of sodium fluorophosphate salt (Na₂PO₃F) was confirmed to have higher kosmotropicity compared to other anions, showing strong interaction with water, a high number of hydrogen bonds, and shortened hydrogen bond length.

### Test Example 2. Reaction Between Dispersing Medium for Producing Cathode Aqueous Slurry and Cathode Active Material

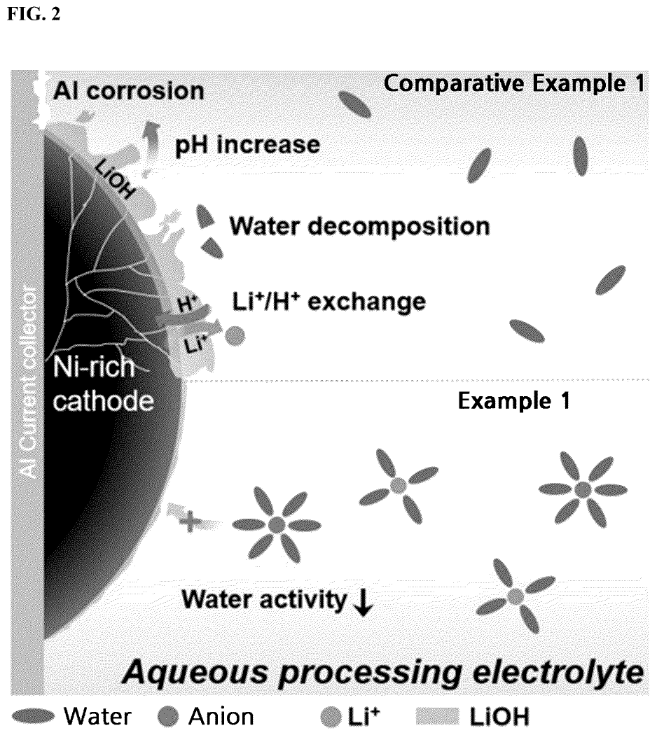

FIG. 2 schematically illustrates the case of using the dispersing medium for producing a cathode aqueous slurry manufactured according to Example 1 and Comparative Example 1 of the present invention.

As shown in FIG. 2, the secondary battery using the dispersing medium for producing a cathode aqueous slurry manufactured according to Example 1 of the present invention suppresses the reactivity of the NCM811 cathode active material vulnerable to moisture toward water by lowering the activity of water compared to the secondary battery of Comparative Example 1, thereby securing a stable interfacial structure and excellent charge/discharge performance. Accordingly, the secondary battery of Example 1 can secure a long life, which is a level similar to secondary batteries manufactured based on existing organic solvents.

In contrast, in Comparative Example 1, it was confirmed that since it does not include a kosmotropic anion (Kosmotropic anion), the activity of water is high, causing side reactions between water and the cathode active material, increasing the basicity of water, and causing corrosion of the current collector.

### Test Example 3. Price Competitiveness

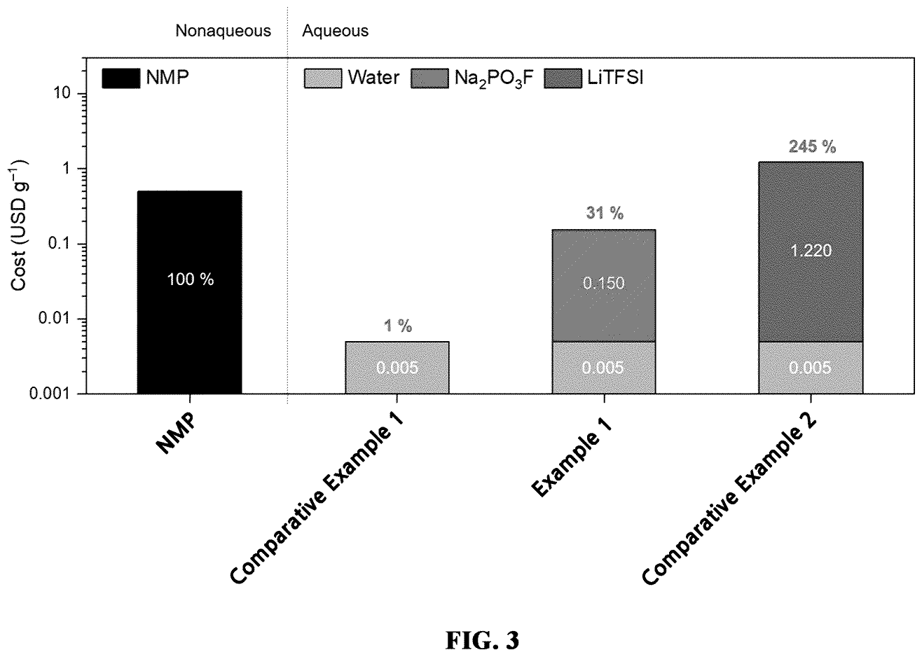

FIG. 3 is a graph measuring the price of the dispersing medium for producing a cathode aqueous slurry manufactured according to Example 1, Comparative Example 1, and Comparative Example 2 of the present invention.

As shown in FIG. 3, the dispersing medium for producing a cathode aqueous slurry manufactured according to Example 1 of the present invention showed a price similar to Comparative Example 1 using water, and was confirmed to have a significantly lower price compared to the dispersing medium for slurry production using the organic solvent (N-Methyl-2-Pyrrolidone, NMP) used in the existing process and the dispersing medium for producing a cathode aqueous slurry of Comparative Example 2.

### Test Example 4. Measurement of Life Characteristics

When the NCM811 cathode active material meets the water in the dispersing medium for producing the cathode aqueous slurry, an exchange reaction occurs between lithium ions in the cathode active material and cations of water, which leads to a decrease in cell capacity.

The NCM811∥Li cells manufactured according to Example 1, Comparative Example 1, and Comparative Example 2 were charged up to 4.25 V at a current density of 0.8 mA cm-2, and then discharged up to 3 V at a current density of 2.0 mA cm-2, which was designated as one cycle, and life characteristics were evaluated by repeating the cycle.

### 4-1. Discharge Specific Capacity

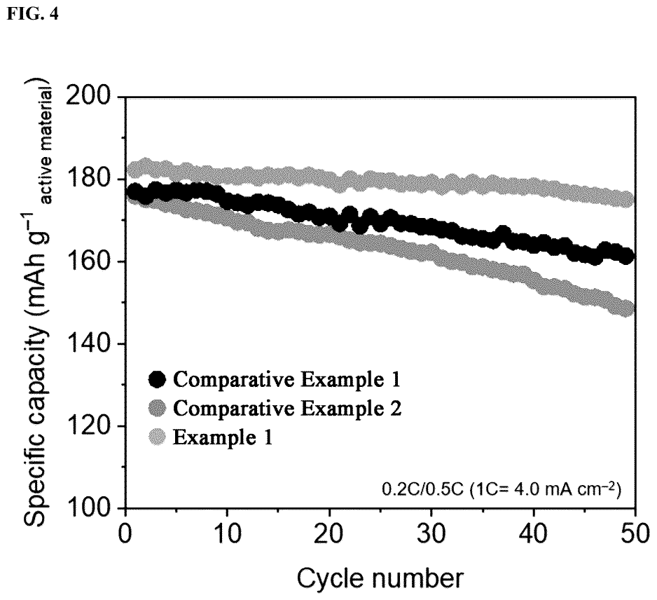

FIG. 4 is a graph measuring the discharge specific capacity of the lithium secondary batteries manufactured according to Example 1, Comparative Example 1, and Comparative Example 2 of the present invention, and the following [Table 1] quantifies the discharge specific capacity after 50 cycles.

TABLE 1

| | | Comparative | Comparative |
|---|---|---|---|
| Classification | Example 1 | Example 1 | Example 2 |
| Discharge Specific Capacity | 175.1 | 161.3 | 148.7 |
| (mAh g⁻¹) | | | |

As shown in FIG. 4 and the above Table 1, it was confirmed that the secondary battery manufactured using the kosmotropic anion according to Example 1 of the present invention has a higher discharge specific capacity compared to Comparative Example 1 and Comparative Example 2.

### 4-2. Capacity Retention Rate

The capacity retention rate for each cycle was calculated by multiplying the ratio of the discharge capacity for each cycle relative to the first discharge capacity by 100.

TABLE 2

| Classification | Example 1 | Comparative Example 1 |
|---|---|---|
| Capacity Retention Rate (%) | 96.1 | 91.1 |

As shown in the above Table 2, it was confirmed that the secondary battery manufactured using the kosmotropic anion according to Example 1 of the present invention has a higher capacity retention rate compared to Comparative Example 1.

1. A dispersing medium for producing a cathode aqueous slurry,
the dispersing medium comprising a metal salt, a water-soluble polymer, and an aqueous solvent,
wherein the anion forming the metal salt is monofluorophosphate (PO₃F²⁻).

2. The dispersing medium for producing a cathode aqueous slurry according to claim 1, wherein the metal cation capable of combining with the anion to form a metal salt is an alkali metal ion, an alkaline earth metal ion, or a transition metal ion.

3. The dispersing medium for producing a cathode aqueous slurry according to claim 2, wherein the alkali metal ion, alkaline earth metal ion, or transition metal ion is selected from the group consisting of Li⁺, Na⁺, K⁺, Rb⁺, Cs⁺, Fr⁺, Be²⁺, Mg²⁺, Ca²⁺, Sr²⁺, Ba²⁺, Ra²⁺, and Zn²⁺.

4. The dispersing medium for producing a cathode aqueous slurry according to claim 1, wherein the metal salt is at least one selected from the group consisting of lithium monofluorophosphate (Li₂PO₃F), sodium monofluorophosphate (Na₂PO₃F), and zinc monofluorophosphate (ZnPO₃F).

5. The dispersing medium for producing a cathode aqueous slurry according to claim 1, wherein the water-soluble polymer is at least one selected from the group consisting of carboxymethyl cellulose (CMC), polyacrylic acid (PAA), polyvinylpyrrolidone (PVP), and polyvinyl alcohol (PVA).

6. The dispersing medium for producing a cathode aqueous slurry according to claim 1, wherein the aqueous solvent is a protic polar solvent.

7. The dispersing medium for producing a cathode aqueous slurry according to claim 1, wherein the aqueous solvent is at least one selected from the group consisting of water, alcohol, acetic acid, and formic acid.

8. The dispersing medium for producing a cathode aqueous slurry according to claim 1, wherein the metal salt is contained at a molar concentration of 0.1 to 5.0 M.

9. The dispersing medium for producing a cathode aqueous slurry according to claim 1, wherein the mixture consisting of the metal salt and the aqueous solvent and the water-soluble polymer are mixed at a weight ratio of 1:0.001 to 0.5.

10. A dispersing medium for producing a cathode aqueous slurry,
the dispersing medium comprising
at least one metal salt selected from the group consisting of lithium monofluorophosphate (Li₂PO₃F), sodium monofluorophosphate (Na₂PO₃F), and zinc monofluorophosphate (ZnPO₃F);
at least one water-soluble polymer selected from the group consisting of carboxymethyl cellulose (CMC), polyacrylic acid (PAA), polyvinylpyrrolidone (PVP), and polyvinyl alcohol (PVA); and
at least one aqueous solvent selected from the group consisting of water, alcohol, acetic acid, and formic acid;
wherein the mixture consisting of the metal salt and the aqueous solvent and the water-soluble polymer are mixed at a weight ratio of 1:0.001 to 0.5, and the metal salt is contained at a molar concentration of 0.1 to 5.0 M.

11. A cathode aqueous slurry comprising the dispersing medium for producing a cathode aqueous slurry of claim 1, a cathode active material, and a conductive material.

12. A cathode comprising: a cathode current collector; and a cathode active material layer manufactured from the cathode aqueous slurry of claim 11 on one surface or both surfaces of the cathode current collector.

13. A secondary battery comprising the cathode of claim 12.

14. A device comprising the secondary battery of claim 13, wherein the device is any one selected from a communication device, a transport device, and an energy storage device.

15. A method for producing a dispersing medium for producing a cathode aqueous slurry, the method comprising
(A) a step of mixing a metal salt and an aqueous solvent; and
(B) a step of mixing the mixed mixture and a water-soluble polymer;
wherein the anion forming the metal salt is monofluorophosphate (PO₃F²⁻).

16. The method for producing a dispersing medium for producing a cathode aqueous slurry according to claim 15, wherein the metal cation capable of combining with the anion to form a metal salt is selected from the group consisting of Li⁺, Na⁺, K⁺, Rb⁺, Cs⁺, Fr⁺, Be²⁺, Mg²⁺, Ca²⁺, Sr²⁺, Ba²⁺, Ra²⁺, and Zn²⁺.

17. The method for producing a dispersing medium for producing a cathode aqueous slurry according to claim 15, wherein the metal salt is at least one selected from the group consisting of lithium monofluorophosphate (Li₂PO₃F), sodium monofluorophosphate (Na₂PO₃F), and zinc monofluorophosphate (ZnPO₃F).

18. The method for producing a dispersing medium for producing a cathode aqueous slurry according to claim 15, wherein the water-soluble polymer is at least one selected from the group consisting of carboxymethyl cellulose (CMC), polyacrylic acid (PAA), polyvinylpyrrolidone (PVP), and polyvinyl alcohol (PVA).

19. The method for producing a dispersing medium for producing a cathode aqueous slurry according to claim 15, wherein the metal salt is contained at a molar concentration of 0.1 to 5.0 M.

20. The method for producing a dispersing medium for producing a cathode aqueous slurry according to claim 15, wherein the mixture consisting of the metal salt and the aqueous solvent and the water-soluble polymer are mixed at a weight ratio of 1:0.001 to 0.5.
